(19) United States
(12) Patent Application Publication
(10) Pub. No.: US 2008/0129543 A1
(43) Pub. Date: Jun. 5, 2008

(54) PORTABLE TRAFFIC SIGNALING DEVICE

(76) Inventor: James Lee, Delray Beach, FL (US)

Correspondence Address: AKERMAN SENTERFITT, P.O. BOX 3188, WEST PALM BEACH, FL, 33402-3188, US

(21) Appl. No.: 11/868,775

(22) Filed: Oct. 8, 2007

Related U.S. Application Data
(60) Provisional application No. 60/828,467, filed on Oct. 6, 2006.

(51) Int. Cl. G08G 1/095

(52) U.S. Cl. 340/908

(57) ABSTRACT

A portable traffic signaling apparatus for controlling the flow of traffic when standard traffic signals are rendered inoperable is provided. The portable traffic signaling system can include portable light boxes, a removable solar panel, removable arm brackets, a vertical mast comprising of an upper portion, middle portion and a lower portion, with the upper portion having the ability to collapse into the lower portion. The apparatus also includes a storage box which houses the main power source of the traffic signals. The apparatus also can include several support legs which have lockable wheels on their terminal ends to allow for easy of movement of the apparatus from one location to another.

### CROSS REFERENCE TO RELATED APPLICATIONS

This application cites for priority provisional application No. 60/828,467, filed Oct. 6, 2006, the disclosure of which is hereby incorporated by reference.

### FIELD OF THE INVENTION

This invention pertains to portable traffic signals utilized when standard signals are rendered inoperable. More specifically, it pertains to a system and method of using a more economically efficient portable traffic signal device.

### BACKGROUND

Numerous signaling devices have been cited in related art. Armstrong (U.S. Pat. No. 5,986,576) discloses an automatically controlled portable traffic signaling device. The programmable signaling device includes a wireless remote control unit and a signal head having LED signal lamp banks and a programmable microprocessor/controller. The signal head and the base are removably connected to a pole receiving device thus allowing for portability.

Fikackek (U.S. Pat. No. 5,805,081) discloses a portable traffic signal. The signal is formed by attaching one or more detachable light panels to the side of a control module. Each light panel is comprised of a rectangular housing and a vertical array of red, amber and green lights mounted in the housing. A tubular sleeve at the lower portion of the control module engages an upper end of a vertical post. The lower end of the post engages a base plate which rests on the road. Movement of the vertical post is prevented by a pair of vehicle wheels which rest on the base plate. The post is preferably made of telescopic sections for compact storage when not in service.

Richardson (US 2005/0270176 A1), shows the preferred embodiment of a mobile traffic light in a fully deployed state. A solar panel is mounted in the center of a platform. The solar panel can be tilted and rotated to a desired position such that a maximum amount of solar energy is captured for a specific time of the year and/or day and for a particular region. Once the panel is positioned, it is locked into place to maintain it at the desired position. When the mobile traffic light is folded for transport, the solar panel is beneath the collapsed first and second members of the actuated arms, which lock the panel in place.

Boeger (U.S. Pat. No. 5,630,675), this patent discloses a two-piece, detachable high-density, low-profile solid base made of recycled rubber products. The mass of the base is concentrated at the periphery in order to maximize the self-righting effect while minimizing the overall weight of the base.

Lange (U.S. Pat. No. 2,401,940) this patent discloses a portable traffic signal comprising of a base member having a receptacle for a storage battery, a standard traffic signal with a telescopic extension member and a traffic signal unit mounted on the upper end of the extension member.

Schaffer (U.S. Pat. No. 6,283,613) this patent discloses an LED single module which includes a casing defining a cavity. Within the cavity is an array of LEDs. Individual reflectors are placed around individual LEDs of the array. The individual reflectors are structured to receive direct light from their associate individual LEDs and substantially to prevent direct light from their associate individual LEDs from impinging upon the individual reflectors of other LEDs or the array of LEDs. Also included and covering the cavity, is a lens shaped to direct the output luminance of the LEDs below a horizontal axis of the module.

Hochstein (U.S. Pat. No. 5,633,629) this patent discloses a traffic information system including a road, a vehicle traveling on the road and a traffic light assembly operatively associated with the road. The system includes a traffic light assembly comprising at least one traffic light or lamp. The traffic light includes a plurality of light emitting diodes for projecting light rays to the vehicle to provide the drive of the vehicle with a visual signal. The system further comprises a transmitter including a power supply and a modulator for turning the diodes on and off at a rate that is imperceivable to humans while optically transmitting information to a receiver disposed on the vehicle.

Hutchinson (U.S. Pat. No. 6,426,704), this patent discloses a modular solid state light apparatus ideally suited for use in traffic control signals. The modular system creates a custom case designed to accommodate current and future features at approximately 1/10 the present cost of a stand alone system. These upgrade features include but are not limited to vehicle preemption, electronically steerable beam, predictive failure analysis, various power supplies. LED arrays in various colors, optical alignment tools used for installation, video cameras, in car Telematics, video loop detection, red light running, various communication links, infrared sensors to sense people and vehicles under fog, rain smoke, and other adverse visual conditions, chemical ‘sniffers’ automobile emission monitoring, and adaptive control. The modular traffic functions are adapted to be selectively added and upgraded over the life of the signal and permitting easy service thereof.

Schmanski (U.S. Pat. No. 4,611,949), this patent discloses a deformable, detachable base for supporting and stabilizing an attached vertical sign or delineator in upright orientation with respect to a ground or road surface to which the base may be affixed. The detachable base includes a deformable, domed structure comprised of a top, intermediate body wall and base attachment channel. The base attachment channel includes first and second channel walls, and a third radial flange which projects inward from the second channel wall toward a central axis of the domed structure. Accordingly, three enclosing walls define a channel enclosure which is utilized to retain the domed structure in attachment to a rigid base plate.

The base plate has a vertically orientated lip at its periphery which is adapted in size and configuration for a tight, contour fit within the channel enclosure. The inventive structure enables easy attachment and removal of the domed structure to the base plate during non-impacting conditions; however, the same domed structure responds to vehicle impact by gripping more tightly at the base plate lip to thereby hold its attached condition despite high speed vehicular impact.

Dechape (U.S. Pat. No. 6,762,689), this patent discloses a traffic signal display apparatus which includes a display surface having a plurality of bicolor bipolar LEDs in a first direction, the bicolor bipolar LEDs display a first color, which may be green. When a current is fed in the opposite direction, the bicolor bipolar LEDs display a second color, which may be red. When a current is fed into the array alternately in both directions, the bicolor bipolar LEDs display a third color, which may be yellow. The display apparatus maybe subdivided into multiple independent zones, allowing arrows to be displayed. The single display apparatus can therefore be used to replace the three to five stacked conventional traffic light display units.

Riscoe, Jr. (U.S. Pat. No. 5,400,019), this patent discloses a portable traffic control device for temporary use capable of both automatic and manual operation which the portable control device can be raised or lowered by hand and having a horizontal boom which folds down to a vertical position and with an adjustable and collapsible tripod stand and an electronic control circuit.

Paquette (U.S. Pat. No. 6,392,563) this patent discloses a traffic light backup system for use with a traffic light. The traffic light backup system includes an auxiliary light associated with at least one of the enclosures housing the traffic lights and rechargeable batteries associated with the auxiliary light. A power failure is detected by monitoring the voltage across the bulbs of the traffic lights and also preferably by monitoring the current in the common, neutral lead. When a power failure has been detected, the traffic light backup system engages and the auxiliary lights are powered by the rechargeable batteries, preferably in a flashing fashion. In a preferred embodiment, the auxiliary light consists of a plurality of LEDs arranged in an octagonal manner. The LEDs have a high luminosity and lower power consumption, which makes them well suited for use even in broad daylight.

Morrison (U.S. Pat. No. 6,118,388), this patent discloses a portable traffic light assembly which includes a substantially rectangular base component having planar upper and lower surfaces and four side walls therebetween. A plurality of wheels are disposed on the lower surface for rolling the device from one location to the next. Extending from the top surface of the base component is a telescoping support leg operable with a hydraulic pump to selectively move the leg between an extended and retracted position. Secured to the upper distal end of the support leg is a traffic light unit having four side walls with a green, yellow and red light on each side wall thereof. The hydraulic lift pump and signal lights maybe selectively operated with a remote control means allowing a user to temporarily direct traffic from a location safely distanced from oncoming traffic.

Gibson (U.S. Pat. No. 4,032,883), this patent discloses a portable traffic signal for serving as a temporary traffic signal. The device being readily portable due to its weight and size so that it can be easily and quickly set up. The device includes a hermetically sealed twelve volt battery, six double lens lights, two of which are red, two of which are green and two of which are amber. A solid state battery charger, an internal timer and a choice of ground rod, tripod or suspension rod are provided.

Koenig (U.S. Pat. No. 4,535,331), this patent discloses a portable traffic warning light having a lower base containing a power supply, a lens housing including a number of electric lamps and lenses are energized, flash and/or display a warning message and a pair of adjustable height columns supporting the lens housing on the base and permitting the height of the lens housing to be adjusted so as to permit ease of viewing by oncoming traffic under a variety of traffic situations.

### SUMMARY OF THE INVENTION

The present invention relates to a portable traffic signaling apparatus to be utilized when standard traffic signals are rendered inoperative. In a preferred embodiment the invention comprises of a removable solar panel which sits atop a vertical mast, light support panels on either side of the mast supported by removable arm brackets extending from the vertical mast, light boxes attached to the light support panels, a storage box which encloses the bottom portion of the vertical mast wherein the power source and wiring to deliver electricity to the light boxes is housed. Extending from the storage box are support legs and at the terminal end of the support legs are lockable wheels to allow for easy movement of the stored apparatus.

A key difference between the present invention and the related art concerns the development of a low cost device. The relative cost of the present invention is lower than the cost of the inventions cited in the related art. Furthermore the technical aspects of the present invention are simpler than previous inventions.

### BRIEF DESCRIPTION OF THE DRAWING FIGURES

FIG. 1 is a front prospective view of the first preferred embodiment of the portable traffic signal apparatus.

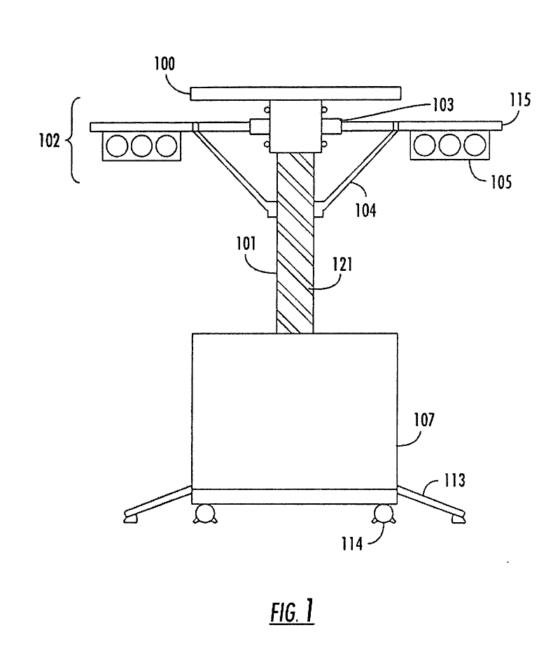

FIG. 2 is a front prospective view of the portable traffic signal apparatus at a lower elevation.

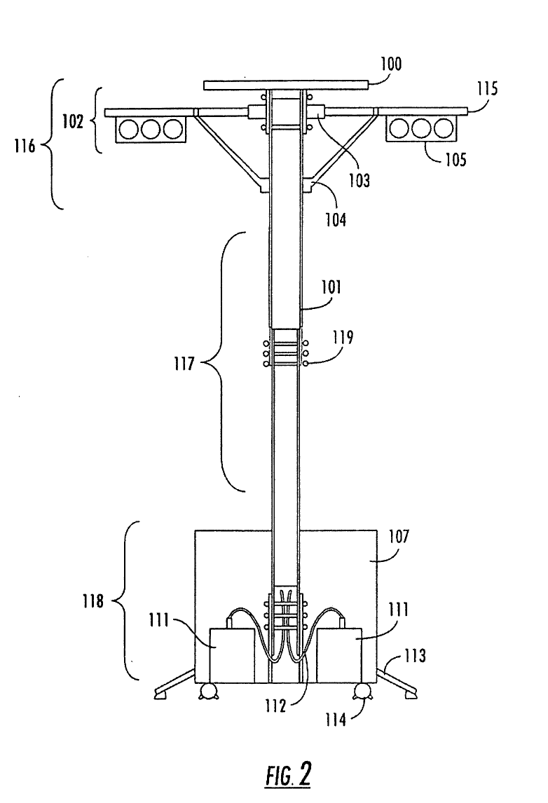

FIG. 3 is a front prospective view of the storage box which will house the solar panels, light boxes and the remaining electrical equipment.

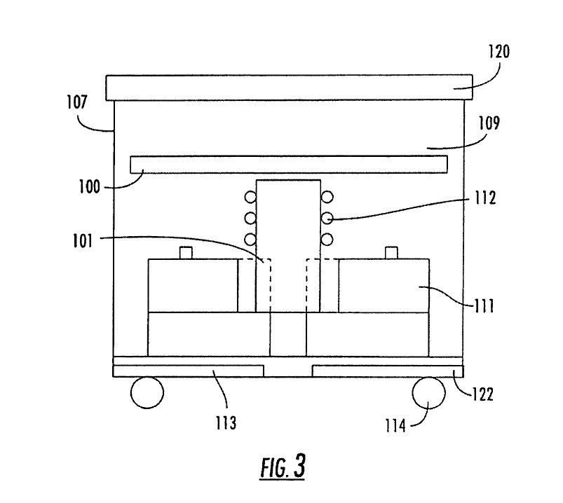

FIG. 4 is a top view of the battery storage box.

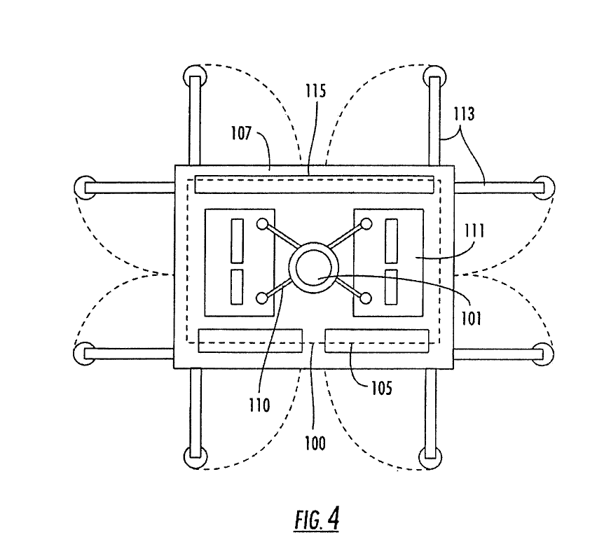

FIG. 5 is a top view of the portable traffic signal apparatus with the solar panels and light support panels fully extended.

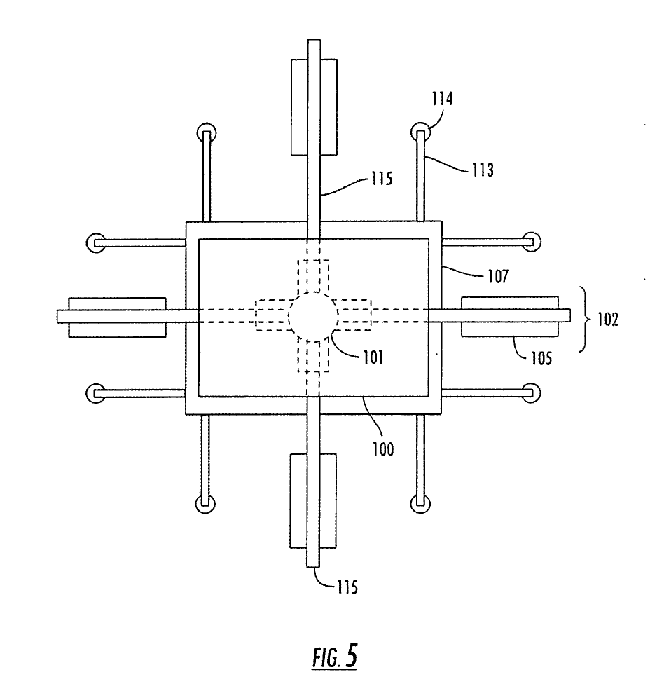

### DETAILED DESCRIPTION OF THE INVENTION

Referring now to the drawings wherein like numerals designate like and corresponding parts throughout the several views. The removable solar panel 100 is attached to the vertical mast 101, said solar panel is 6 inches above the removable light panels 102. The light panels extend 48 inches on either side of the vertical mast. Said light panels terminate into brackets 103 designed to receive the light panel supports 115. These brackets also receive the electrical wiring from the vertical mast and form a “cap” on the light support panels 115. The removable light support panels 115 are supported by 12 inch removable arm brackets 104. These brackets originate from the light pole and terminate in the position on the light support panel which is behind the “cap” brackets and in front of the removable light boxes 105. These brackets are removable from the vertical mast 101 and can be stored with the light boxes 105 in the storage box 107 at the base of the apparatus.

Connected to the light support panel are the removable light boxes 105. These light boxes 105 measure 18 inches long, 6 inches wide and 6 inches deep. The light boxes comprise a red, amber and green light. In one preferred embodiment the light boxes 105 are attached in a horizontal position to the support panels 115. In yet another preferred embodiment, the light boxes 105 are hung vertically, extending downward from the support panel 115.

The portable traffic light contains a vertical mast 101. The mast contains an upper 116, middle 117 and lower portion 118. All portions have circular cross sections. These cross sections contain the wiring which will deliver electricity to the unit. At the mid-point of the vertical mast, approximately 72 inches, pull-pin bolts 119 are used to secure the vertical mast once the mast is extended. The lower portion of the vertical mast, which extends from right below the final pull-pin bolt to the bottom of the mast is about 72 inches.

The final 42 inches of the vertical mast extend into the storage box 107. The storage box 107 has a height of about 42 inches and a width of about 48 inches. The front of the storage box 107 is comprised of a hinged portion 120 wherein the front of the box 107 can be flipped up to allow for easy storage of the portable traffic light. The area behind the hinged side 109 is reserved for storing the solar panels 109.

The lower portion of the vertical mast 118 contains 6 battery connections 110, three on each side of the mast 101. These connections 110 receive the wiring from the batteries 111 located on either side of the vertical mast base. Each of these batteries 111 contains a timer designed to synchronize the traffic signals. The two batteries 111 have wiring 112 extending from the top of the battery to the connections 112 located on the base of the vertical mast 101.

On the underside of the storage box 107 is a recess area to allow for the storage of the support legs 113. The support legs 113 are comprised of ½ inch of aluminum with a rubber pad. At the terminal end of the support legs 113 are lockable wheels 114. The support legs 113 fold under the box 107 to allow for easy storage of the entire unit. The wheels 114 allow for ease of transportation of the apparatus from one location to another.

There are several differences between the design of the present invention and related art. The design of the present invention is simpler and more efficient. Related inventions of this nature include systems designed for optical alignment tools, sensing pedestrians and vehicles under fog, LED arrays in various colors and detecting automobile emissions. The related inventions focus on these other aspects of using similar types of portable light apparatus.

What is claimed:

1. A portable traffic signal comprising: a solar panel; a vertical mast; two light support beams on either side of the vertical mast wherein the mast comprises an upper portion, a middle portion and a lower portion forming the base of the mast wherein the cross section of the mast contains the wiring necessary to deliver electricity to the light boxes; light boxes attached to the support beams wherein the light boxes contain a green, red and amber light; removable arm brackets supporting the light panel supports; a support box enclosing the base of the mast; a power source at the base of the mast; support legs on each corner of the storage box and lockable wheels at the terminal end of the support legs.

2. A traffic signal as in claim 1, herein the power source comprises a timer to synchronize traffic flow.

3. A traffic signal as in claim 1, wherein the storage box has a front side with a hinge for the purpose of easier storage of the unit.

4. A traffic signal as in claim 1, wherein the power source is a battery or batteries in the storage box.

5. A traffic signal as in claim 1, wherein the electrical means of operating the signal comprises electrical wires extending from the batteries in the storage box, through the connections in the base of the vertical mast, extending through the middle and upper part of the mast into the light support brackets and terminating into the light boxes.

6. A traffic signal as in claim 1, wherein the bottom half of the unit is covered in reflective tape.

7. A traffic signal as in claim 1, wherein the supporting legs are on each corner of the storage box.

8. A traffic signal as in claim 1, wherein underneath the storage box is a recessed area to allow for the support legs to fold under the box.

9. A traffic signal as in claim 1, wherein the support legs have a width of about ½″ of aluminum and a rubber padding.
